(19) United States
(12) Patent Application Publication
(10) Pub. No.: US 2014/0194149 A1
(43) Pub. Date: Jul. 10, 2014

(54) SINGLE TRANSCEIVER FOR USE WITH MULTIPLE CELLULAR NETWORKS

(71) Applicant: GENERAL MOTORS LLC, Detroit, MI (US)

(72) Inventors: Nadav Lavi, Ramat-Hasharon (IL); Kobi Jacob Scheim, Pardess Hanna (IL); Andrew J. Macdonald, Grosse Pointe Park, MI (US); Ron Rotstein, Herzlia Pituach - Tel Aviv (IL)

(73) Assignee: GENERAL MOTORS LLC, Detroit, MI (US)

(21) Appl. No.: 13/737,396

(22) Filed: Jan. 9, 2013

(51) Int. Cl. H04W 88/06; H04W 68/00

(52) U.S. Cl. CPC H04W 88/06; H04W 68/00
USPC 455/458

(57) ABSTRACT

A system and method for wirelessly communicating over two wireless networks having different communication protocols using a single transceiver of a vehicle telematics unit. The method includes monitoring a first network for an incoming page using a transceiver and a first network access device (NAD); the transceiver and the first NAD may be components of a cellular device, such as a vehicle telematics unit. The method includes monitoring a second network for another incoming page using the same transceiver and a second NAD. The second NAD also may be a component of the cellular device. When a page is received over the second network, a call may be connected using the second NAD, and the first network may be periodically monitored for an incoming page without disconnecting the call of the second network.

### TECHNICAL FIELD

The present invention relates generally to wireless communication devices, and more specifically to engaging multiple cellular networks using a device having a single transceiver.

### BACKGROUND OF THE INVENTION

Access to a cellular network via a cellular device typically requires that the device contains particular electronics. For example, in order to access a CDMA network, among other things, the device must include electronics compatible with CDMA technology. Likewise, to access a LTE network, among other things, the device must include electronics compatible with LTE technology. In part, these electronics may include a chipset; i.e., either a CDMA chipset or an LTE chipset. Various CDMA and LTE chipsets exist providing cellular users with solutions for different types of mobile devices and improved or enhanced performance.

### SUMMARY OF THE INVENTION

According to an aspect of the invention, there is provided a method of wirelessly communicating with a single transceiver of a cellular device over two wireless networks having different communication protocols. The method may include monitoring a first network for an incoming page using a transceiver and a first network access device (NAD). The transceiver and the first NAD may be components of a cellular device. The method may also include monitoring a second network for another incoming page using the transceiver and a second NAD; and the second NAD may be a component of the cellular device as well. The monitoring steps may be accomplished using a processor that toggles the connection of the first NAD with the first network and second NAD with the second network.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein;

FIG. 2 is an architecture diagram illustrating some of the components of a telematics unit for a vehicle;

FIG. 3 is a graph illustrating an LTE idle mode and a CDMA idle mode activation patterns;

FIG. 4 is a flow diagram illustrating various states of the telematics unit utilizing an LTE chipset and a CDMA chipset; and

FIG. 5 is a flowchart illustrating one method of using the LTE and CDMA chipsets.

### DETAILED DESCRIPTION OF THE ILLUSTRATED EMBODIMENT(S)

The method described below enables a telematics unit in a vehicle to communicate with multiple cellular networks using a single radio or transceiver. This is accomplished by making use of periods or durations of time when the transceiver is not actively listening to the other network (e.g., for an incoming page (i.e., a paging event) or call) or not sending/receiving voice or data information over that network. Thus, the method below may apply an algorithm and/or utilize hardware and/or software/logic applications to time the switching or toggling between the two networks to enable such communication. In one embodiment described below, a first network is an LTE network and a second network is a CDMA network, and communication over the CDMA network is given higher priority.

Communications System—

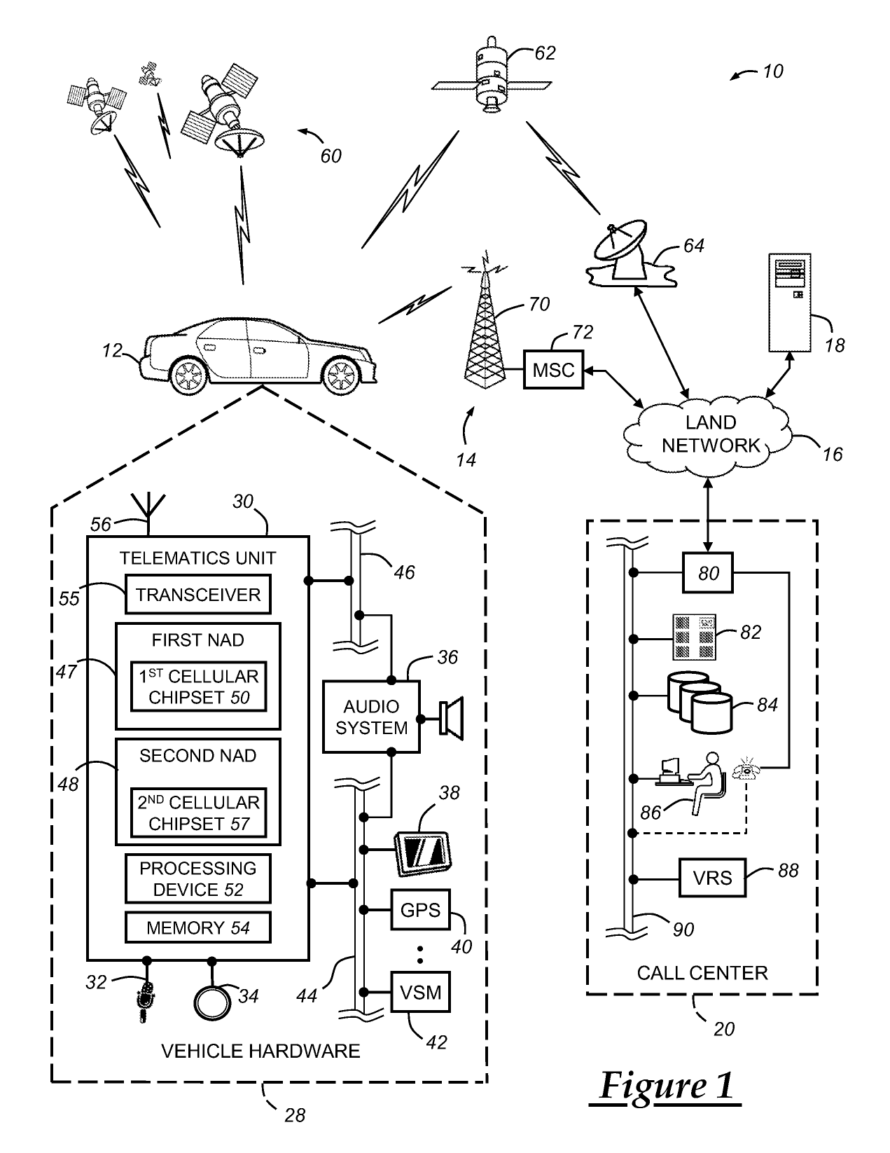

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well. For example, the environment may include a communication system without the inclusion of a vehicle (e.g., cellular phone to cellular phone).

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that enables wireless voice and/or data communication over wireless carrier system 14 and via wireless networking so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to 3GPP technologies such as: 2nd generation GSM/GPRS/EDGE; 3rd generation WCDMA/HSPA; and more recent generation technologies such as Long-Term-Evolution LTE and Advanced-LTE). It may include a first network access device (NAD) 47, a transceiver 55 for transmission and reception of wireless communications, a wireless modem for data transmission, a processor which may include a selection and/or decision device 52, one or more digital memory devices 54, and a dual-band antenna 56. As used herein, a network access device (NAD) may be electronics or an electronic circuit that is used to connect a user to a selected wireless network. For example, the first NAD may include a first chipset or a standard cellular chipset 50 used generally for voice communications like hands-free calling. And the first chipset 50 may be a CDMA chipset. It should be appreciated that a single- (rather than a dual-band) antenna may also be utilized. Furthermore, it should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

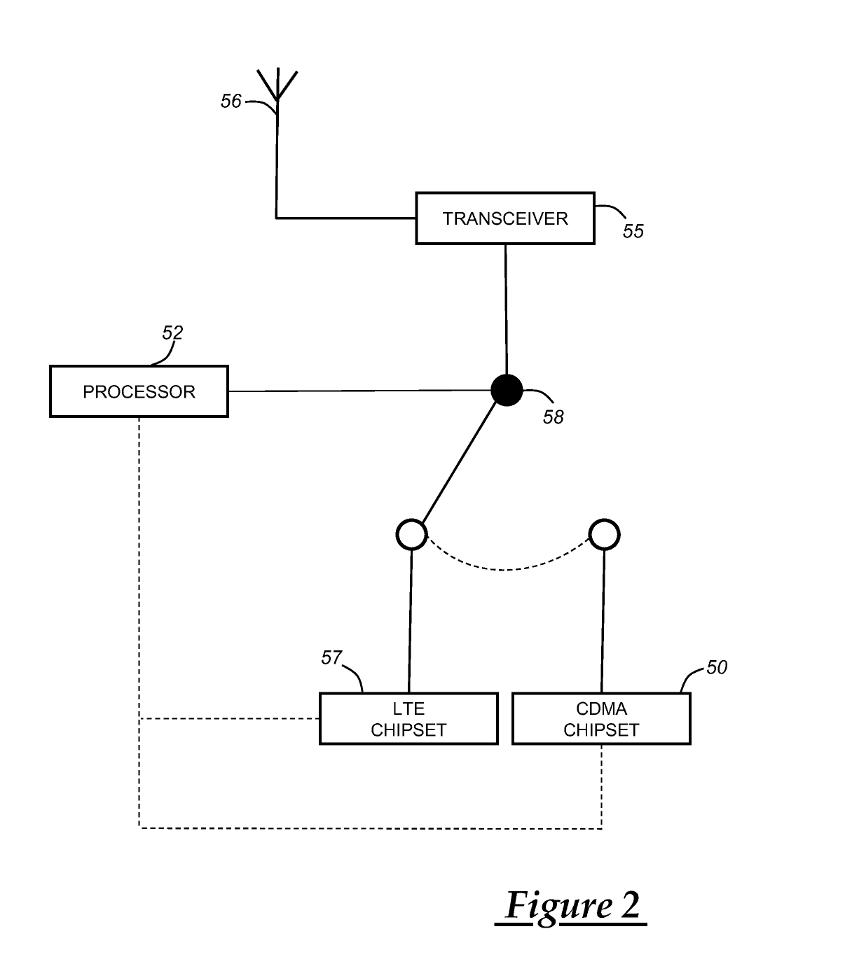

In one embodiment, the telematics unit 30 may include a second NAD 48 (see FIGS. 1-2). The first NAD 47 includes the first cellular chipset 50 (e.g., a CDMA chipset) and the second NAD 48 includes a second cellular chipset 57 (e.g., an LTE chipset). The chipsets 50, 57 are both coupled to the processor 52 and are also coupled to a switching element 58. The switching element 58 is coupled to the transceiver 55 and the processor 52 which controls its actuation. Thus, the switching element 58 toggles between the first and second chipsets 50, 57 and allows communication therethrough to the transceiver 55. In the illustrated example the second chipset 57 is an LTE chipset. The switching element may be hardware switch (e.g., a transistor) or it may be a software or firmware switch (e.g., instructions executed by the processor 52). As used herein, the term instructions may include for example, control logic, computer software and/or firmware, programmable instructions, or other suitable instructions. And the term processor may include, for example, one or more microprocessors, microcontrollers, application specific integrated circuits, programmable logic devices, and/or any other suitable type of processing device. Thus, the switching element 58 shown in FIG. 2 may merely be illustrative of the processor's 52 functionality. In order to determine when to switch, the processor 52 may utilize existing protocols or standards information (i.e., information pertaining to, e.g. CDMA and/or LTE technology) and/or information received from the cellular network; e.g., information received at the time of receipt of a call or page, as will be described in greater detail below.

It should be appreciated that the first and second chipsets may be two distinct components or they may be a single component—e.g., a dual chipset such as a QUALCOMM MDM9615. It should also be appreciated that use of a CDMA chipset and an LTE chipset is also exemplary. Other communication protocols may be used (e.g., GSM—utilizing another GSM chipset).

Returning to FIG. 1, processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as one or more vehicle system modules located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

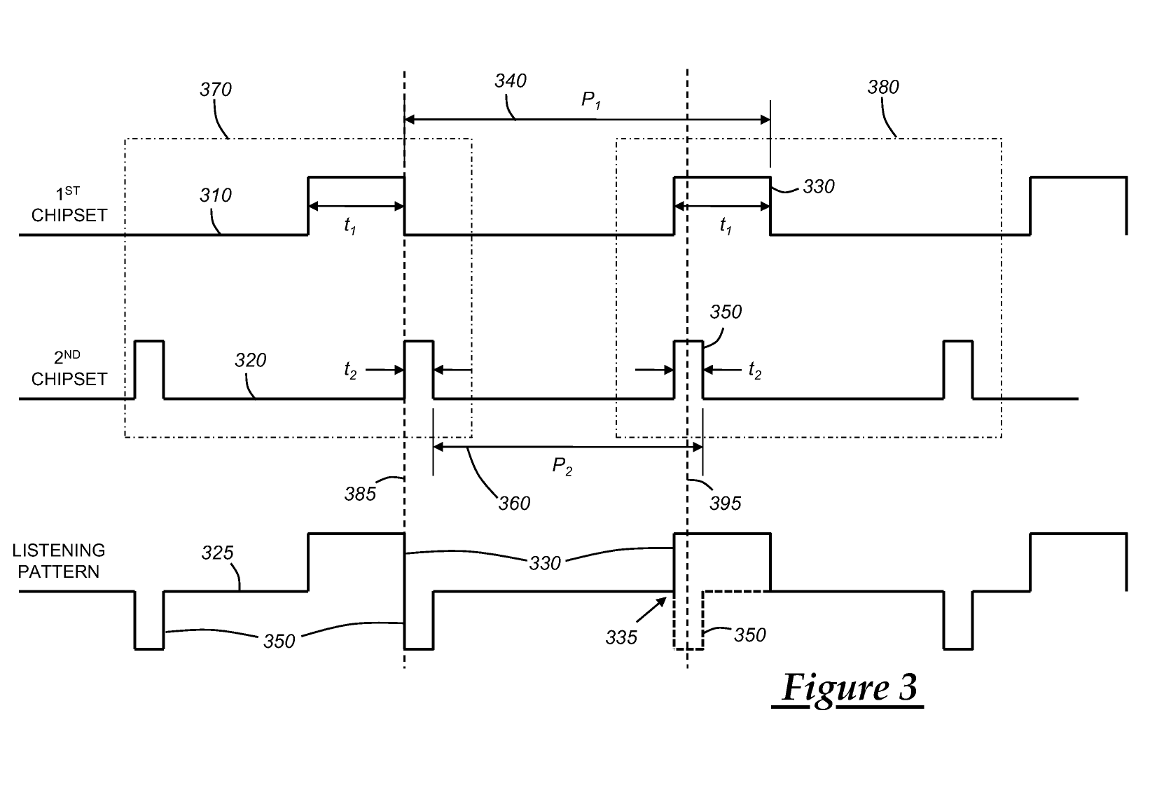

Now turning to FIG. 2, there is shown a schematic of various system components from FIG. 1 that may be used to implement a method of wirelessly communicating from the telematics unit 30 with multiple cellular networks using the single transceiver 55. The telematics unit 30 communicates with at least two cellular networks by toggling back and forth therebetween according to a pattern that lessens the chance of missing an incoming call over any network to which the telematics unit is connected. In the illustrated examples below (FIGS. 3-5), the telematics unit 30 communicates via the transceiver 55 with a first cellular network (a CDMA network) using the first chipset 50 and a second cellular network (an LTE network) using the second chipset 57. It may be desirable for the telematics unit 30 to use the CDMA network primarily for voice communications (i.e., opening/using voice sessions) and the LTE network primarily for data communications (i.e., opening/using data sessions). However, this illustration is merely exemplary and other networks may be communicated therewith. In addition, the transceiver 55 is located in a vehicle, more specifically in the vehicle telematics unit; however, this environment is merely exemplary too. Thus, this method may be used in non-vehicle environments as well.

Those skilled in the art will appreciate that cellular networks have several call processing modes and channels used during cellular communication. For example in CDMA networks, to initiate and/or host a call, there may be an initialization mode, an idle mode, an access mode, and a traffic mode. Channels include a pilot channel, a synchronization channel, an access channel, a paging channel and a traffic channel. In the initialization mode, the telematics unit 30 may acquire a pilot channel and synchronize with the synchronization channel. In the idle mode, the telematics unit 30 has an opportunity to receive a page (e.g., during a paging event); in addition, the telematics unit 30 may communicate with the base station over the access and paging channels while not engaged in a call during the idle mode. For example, during initialization, the telematics unit 30 may receive information pertaining to when to listen for an incoming page (or call or transmission)—or when to be in the idle mode. More specifically, this information may include a predetermined length of time to listen for a page (or a listening interval) and the listening interval's periodicity (e.g., for use by the telematics unit in a listening mode). When not in the idle mode, the chipset (e.g., either 50 or 57) may be OFF in order to conserve or save energy and/or power consumption. And when in the idle mode, the chipset (e.g., either 50 or 57) may be ON and may listen for a page over the paging channel for the predetermined interval (and the listening interval may be periodic).

Turning now to FIG. 3, there is shown two exemplary paging opportunity patterns for the CDMA and LTE networks; e.g., FIG. 3 illustrates an exemplary ON/OFF idle mode pattern 310 for a first cellular network (CDMA) and an exemplary ON/OFF idle mode pattern 320 for a second cellular network (LTE). In the CDMA network, there is shown a predetermined interval t₁ 330 which recurs with a predetermined period P₁ 340. In the LTE network, there is shown a predetermined interval t₂ 350 which recurs with a predetermined period P₂ 360. As will be appreciated by skilled artisans, the interval t₁, the interval t₂, the period P₁, and the period P₂ may be predetermined and according to an industry specification; e.g., in at least one implementation the values may be in accordance with previous, current, or future 3rd Generation Partnership Project (3GPP) standards (e.g., 3GPP, 3GPP2, etc.). Thus, in one example, the values for t₁ and t₂ may be: t₁=80 milliseconds (ms), t₂=1 ms; and the values for P₁ and P₂ may be: 1.28 seconds≦P₁≦163.84 seconds (e.g., 1.28 sec, 2.56 sec, . . . , 163.84 seconds), and 320 ms≦P₂≦2560 ms (e.g., 320 ms, 640 ms, 1280 ms, 2560 ms). It should be appreciated that the 3GPP and 3GPP2 standards are merely exemplary and that other industry specifications may be used (including later developed or later generation specifications). Therefore, as shown, there will be instances or regions 370 where one of the intervals t₁ of the CDMA network does not coincide with or overlap one of the intervals t₂ of the LTE network. In these instances, the telematics unit 30 may be listening in the idle mode in the CDMA network and switch (e.g., via the switching element 58) to listening in the idle mode of the LTE network without missing a potential page over either network (i.e., no collision 385). However, there may be instances or regions 380 where one of the intervals t₁ of the CDMA network does coincide with or overlap one of the intervals t₂ of the LTE network. These instances or collisions 395 may result in a missed paging opportunity.

The transceiver 55 may be configured to listen in the idle mode over the CDMA network and then switch and listen in the idle mode over the LTE network. This enables the telematics unit 30 to listen for a page over multiple networks using only one transceiver 55. In one implementation, the telematics unit switches back and forth between networks according to a predetermined listening pattern 325 in order to effectively listen for an incoming call over both networks, as shown in FIG. 3. This listening pattern may be determined during initialization; e.g., the processor 52 determine or configure the listening pattern 325 based at least in part on information received during synchronization. Furthermore, the listening pattern may be configured to minimize the number of collisions and/or it may give priority to one of the networks (e.g., to the network providing voice communication). In FIG. 3, the pattern 325 gives priority to the CDMA network—i.e., when a collision 335 occurs, the telematics unit 30 does not listen to the second cellular network for the interval 345, but instead listens to the first cellular network for the interval 355. The processor 52 may implement the listening pattern 325 using the switching element 58 (of course, the processor could directly control the chipsets 50, 57 as well or instead). In one embodiment, the number of collisions that may occur during the operation of the chipsets 50, 57 in their respective idle modes is determinable and suitable for commercial use. For example, in one implementation, in 50% of all the configuration scenarios, the collision probability may be no more than 10%. In another implementation, it has been empirically determined that in approximately 25% of all configuration scenarios the collision probability is no greater than approximately 25%; in another approximately 25% of all configuration scenarios the collision probability is no greater than approximately 12.5%; in approximately 28% of the remaining configuration scenarios the collision probability is no greater than approximately 6.25%; and in approximately the final 22% of all configuration scenarios the collision probability is no greater than approximately 3.13%.

Now turning to instances of when a page is received using the CDMA and LTE chipsets 50, 57 over one of the networks—if during the listening pattern 325 a page is received over the CDMA network by the CDMA chipset 50 and a call results, the CDMA chipset ‘camps on’ the CDMA network. And the LTE chipset 57 is no longer able to listen for a page or an incoming call. However, the converse is not true. If during the listening pattern 325 a page is received over the LTE network by the LTE chipset 57 and a call results, it is possible under certain circumstances for the CDMA chipset 50 to listen on the CDMA network (i.e., in an idle mode). While the LTE chipset 57 is camped on the LTE network, the processor may control the switching element 58 to momentarily allow the CDMA chipset 50 to listen over the CDMA network. Provided the listening over the CDMA network is momentary, the LTE network will perceive that the LTE chipset 57 has momentarily disappeared or disconnected (e.g., due to a radio channel fade, etc.). And the LTE call may not be terminated, and data may not be lost during transmission, because current LTE technology includes various mechanisms and/or provisions that enable continuous LTE communication despite any such momentary disappearances or disconnections. Examples of such mechanisms include automatic repeat request (ARQ) or hybrid automatic repeat request (HARM). Thus, it is possible to be in an idle mode in the CDMA network while being engaged in a call (or data session) in the LTE network.

Another possibility exists for being in a CDMA idle mode while being engaged in a call over an LTE network (using a single transceiver 55)—i.e., when the LTE chipset 57 is using discontinuous reception (or DRX). Once a call is engaged over the LTE network using DRX, the CDMA chipset 50 may still listen during periods when the LTE chipset 57 is not actively sending or receiving a transmission.

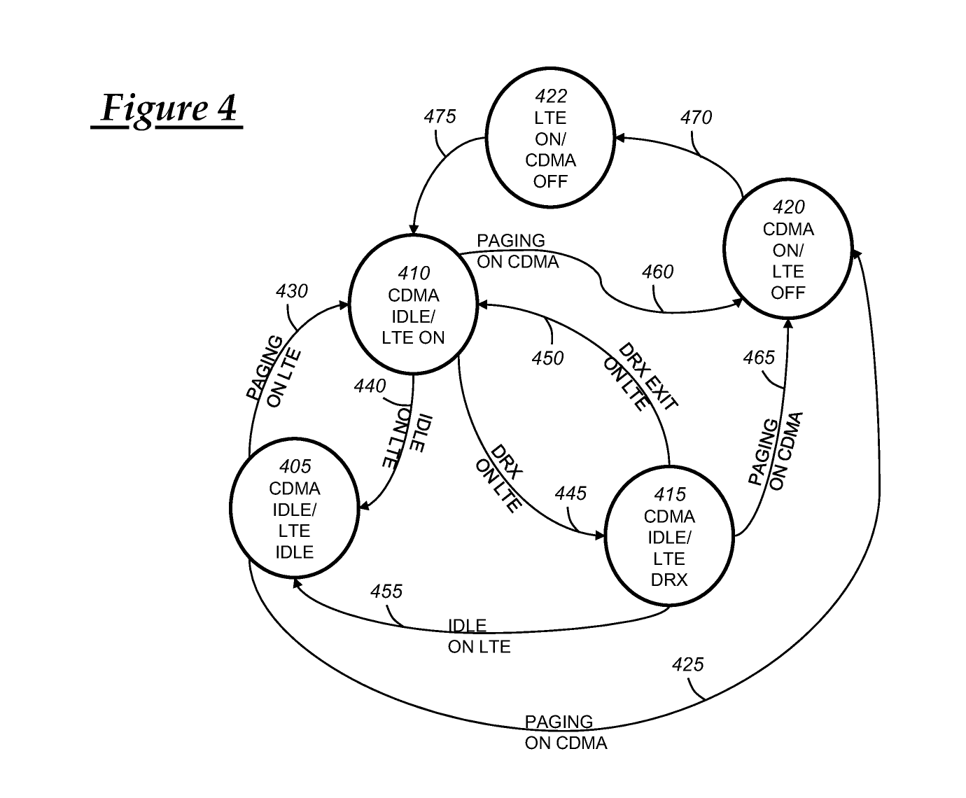

FIG. 4 is a flow diagram and illustrates the interaction of the CDMA and LTE chipsets 50, 57 with the CDMA and LTE networks, respectively. FIG. 4 illustrates five different states: state 405 (the CDMA and LTE chipsets 50, 57 are in idle mode); state 410 (the CDMA chipset 50 is in idle mode while the LTE chip 57 is camped on); state 415 (the CDMA chipset 50 is in idle mode while the LTE chipset 57 is in the DRX mode); state 420 (the CDMA chipset 50 is camped on while the LTE chipset 57 is not active); and state 422 (CDMA chipset 50 is OFF and LTE chipset 57 is reconnecting).

In state 405 (CDMA IDLE, LTE IDLE), a page and/or call may be received from the CDMA network 425 or the LTE network 430. In at least one embodiment, paging on the CDMA network may be given higher priority than the LTE network (e.g., over any LTE paging, currently engaged LTE calls, or LTE data sessions). Thus, if there is a page over CDMA 425, the state may change to state 420 (CDMA ON, LTE OFF). If the page is over LTE 430, the state may change to state 410 (CDMA IDLE, LTE ON). And if the LTE page/call ends (or terminates) 440, the state may return to state 405 (CDMA IDLE, LTE IDLE). If during state 410 (CDMA IDLE, LTE ON), the call becomes DRX 445, state 410 may change to state 415 (CDMA IDLE, LTE DRX). And, if the DRX session ends (or terminates) 450, state 415 may return to state 410 (CDMA IDLE, LTE ON). It is also possible to change from state 415 (CDMA IDLE, LTE DRX) to state 405 (CDMA IDLE, LTE IDLE) if the LTE session ends (or terminates) 455. In the embodiments where CDMA is given priority, a CDMA page/call may be received during an LTE session or during an LTE DRX data session. For example, if during state 410 (CDMA IDLE, LTE ON), a CDMA page is received 460, the state may change from state 410 to state 420 (CDMA ON, LTE OFF). Similarly, if during state 415 (CDMA IDLE, LTE DRX), there is a page over CDMA 465, the state may change from state 415 to state 420 (CDMA ON, LTE OFF). Lastly, in instances where a CDMA call ends (e.g., from state 420 (CDMA ON, LTE OFF)), the state may change from state 420 to state 422 (CDMA OFF, LTE RECONNECT) where the LTE chipset 57 may attempt to reconnect with a nearby base station 470. From state 422 (CDMA OFF, LTE RECONNECT), the LTE chipset may reconnect 475 and the state may change from state 422 to state 405 (CDMA IDLE, LTE IDLE).

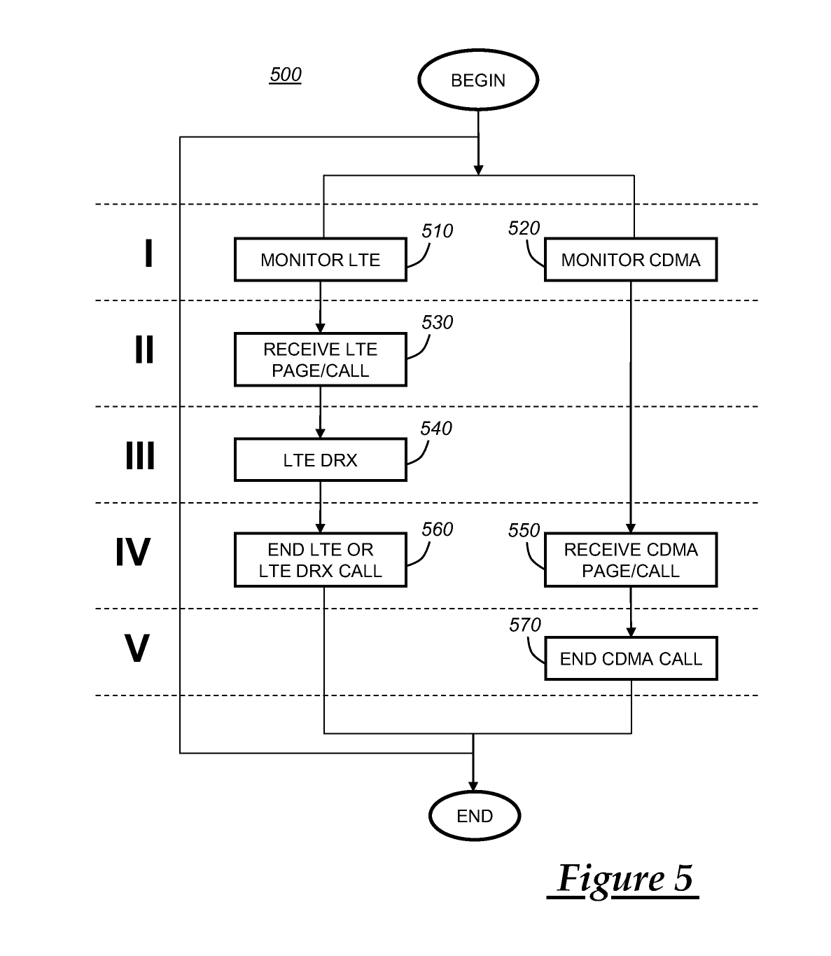

FIG. 5 is a flowchart illustrating one embodiment of a method of wirelessly communicating over two wireless networks having different communication protocols using the transceiver 55 associated with telematics unit 30. The flowchart is divided into five different stages to illustrate the timing of the events in the flowchart (I, II, III, IV, V). The method begins at step 510—a second network is monitored for a page or a call using transceiver 55 and the second NAD 48. In step 520, a first network may be monitored for an incoming call or page using the transceiver 55 and the first NAD 47. In one embodiment the first NAD and the second NAD may include the first chipset 50 and the second chipset 57, respectively. In addition, the first network may be the CDMA network and the second network may be the LTE network. Steps 510 and 520 occur during stage I (to illustrate that they may monitored according to a toggling/listening mode). In step 530 (stage II), an incoming call or page may be received over the LTE network using the transceiver 55 and the LTE chipset 57 while step 520 continues (by toggling between the LTE and CDMA networks). In stage III, the LTE call changes to LTE DRX 540 while step 520 continues. In stage IV, a page is received on the CDMA network 550, and the LTE DRX session terminates 560. In stage V, the LTE network is not being monitored, and the CDMA call ends or terminates 570. After stage V, the flowchart either ends or returns to the beginning to start over (continuously monitoring both LTE and CDMA networks 510, 520 by toggling therebetween).

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of wirelessly communicating with a single transceiver of a cellular device over two wireless networks having different communication protocols, comprising the steps of:
monitoring a first network for an incoming page using a transceiver and a first network access device (NAD), wherein the transceiver and the first NAD are components of a cellular device; and
monitoring a second network for another incoming page using the transceiver and a second NAD, wherein the second NAD is a component of the cellular device;
wherein the monitoring steps are accomplished using a processor that toggles the connection of the first NAD with the first network and second NAD with the second network.

2. The method of claim 1 wherein the first network is a CDMA network and the second network is an LTE network, and wherein the first NAD includes a CDMA chipset and the second NAD includes a LTE chipset.

3. The method of claim 2 wherein the CDMA chipset and the LTE chipset are located on a dual chipset.

4. The method of claim 2 further comprising the step of connecting a call over the LTE network associated with an incoming page and continuing to monitor the CDMA network for an incoming page.

5. The method of claim 4 further comprising changing the LTE call to LTE discontinuous reception (DRX) and continuing to monitor the CDMA network for an incoming page.

6. The method of claim 5 wherein when an incoming page over CDMA is connected as a CDMA call, any currently connected LTE call or LTE DRX call is disconnected.

7. The method of claim 1 further comprising the step of receiving synchronization information during initialization pertaining to the idle mode interval length t₁ for the first cellular network and synchronization information during initialization pertaining to the idle mode interval length t₂ for the second cellular network.

8. The method of claim 7 wherein length of t₁ and t₂ is defined according to a 3rd Generation Partnership Project (3GPP) standard or a 3GPP2 standard.

9. The method of claim 8 wherein t₁ is approximately 80 milliseconds (ms) and t₂ is approximately 1 ms.

10. The method of claim 8 wherein for 50% of the configuration scenarios, the collision probability is no more than 10%.

11. The method of claim 8 wherein, for all scenarios, the probability of a collision of the listening intervals due to toggling between the LTE and CDMA networks using the transceiver may be determined statistically, such that collisions occur less than or equal to 25% of the time in 25% of the scenarios, less than or equal to 12.5% in another 25% of the scenarios, less than or equal to 6.25% in 28% of the scenarios, and less than or equal to 3.13% in 22% of the scenarios.

12. The method of claim 1 wherein the cellular device is a vehicle telematics unit.

13. A computer program product, comprising: a non-transitory computer readable medium for a cellular device having a first network access device (NAD), a second network access device (NAD) and a single transceiver, comprising one or more software programs stored on the computer readable medium that include program instructions to camp the cellular device on the first network or the second network upon identification of a paging event by the cellular device, wherein if the paging event is received over the first network, the instruction camps the cellular device on the first network, and if the paging event is received over the second network, the instruction camps the cellular device on the second network.

14. The computer program product of claim 13 wherein the instructions include toggling between the first and second networks according to a predetermined listening pattern.

15. The computer program product of claim 13 wherein the cellular device is a vehicle telematics unit.

16. The computer program product of claim 13 wherein the first network is a CDMA network and the second network is a LTE network.

17. The computer program product of claim 16 further comprising an instruction to connect a call in response to a first paging event on the LTE network, wherein the instructions further comprise periodically toggling between the LTE network and the CDMA network to listen for a second paging event on the CDMA network.

18. The computer program product of claim 17 further comprising an instruction to disconnect the call in response to the second paging event on the CDMA network.

19. The computer program product of claim 17 further comprising an instruction change the call over the LTE network to LTE discontinuous reception (DRX) and continuing to periodically toggle between the LTE network and the CDMA network to listen for the second paging event on the CDMA network.

20. The computer program product of claim 19 further comprising an instruction to disconnect the DRX call in response to the second paging event on the CDMA network.
